(19) United States
(12) Patent Application Publication
(10) Pub. No.: US 2015/0049945 A1
(43) Pub. Date: Feb. 19, 2015

(54) IMAGE PROCESSING APPARATUS AND IMAGE PROCESSING METHOD

(71) Applicant: HTC CORPORATION, (US)

(72) Inventors: Ruey-Jer CHANG, TAOYUAN CITY (TW); Meng-Chieh YEH, TAOYUAN CITY (TW); Lun-Cheng CHU, TAOYUAN CITY (TW); Wei-Chung YANG, TAOYUAN CITY (TW)

(73) Assignee: HTC CORPORATION, TAOYUAN CITY (TW)

(21) Appl. No.: 13/870,479

(22) Filed: Aug. 19, 2013

(51) Int. Cl. G06T 7/00; G06K 9/00; G06T 3/60

(52) U.S. Cl. CPC G06T 7/0081; G06T 3/60; G06K 9/00241; G06K 9/00375
USPC 382/173

(57) ABSTRACT

An image processing apparatus and an image processing method are provided. The image processing apparatus comprises a processor which divides an original image into a plurality of group images and rotates each of the group images by an angle to generate an output image.

### FIELD OF THE INVENTION

The present invention relates to an image processing apparatus and an image processing method. More particularly, the image processing apparatus of the present invention divides an original image into a plurality of group images and rotates each of the group images by an angle to generate an output image.

### DESCRIPTIONS OF THE RELATED ART

With widespread use of image capturing apparatuses (e.g., cameras, video recorders and any handled apparatuses equipped with an image capturing module), people can record every little thing in life through use of the image capturing apparatuses.

For example, members attending a meeting usually record their respective notes with pens and paper. After the meeting, a member who desires to obtain notes of another member usually captures images of the notes one by one using an image capturing apparatus, or captures an image of the notes all at once and then divides the image containing all the notes into a plurality of images corresponding to the respective notes one by one by manually operating an image processing software.

However, the aforesaid practice is quite inconvenient and time consuming, which is particularly the case when there are quite a few of members attending the meeting. Accordingly, an urgent need exists in the art to provide a relatively convenient image capturing and image processing mechanism that allows users to obtain images of respective notes more directly and quickly.

### CONTENTS OF THE INVENTION

An objective of the present invention is to provide an image processing apparatus and an image processing method thereof The image processing apparatus divides an image containing a plurality of notes into a plurality of group images each corresponding to one note. Then, the image processing apparatus rotates each of the group images by an angle to generate an output image. In this way, the output image displays the respective notes upright to be read by a user.

To achieve the aforesaid objective, the present invention discloses an image processing apparatus which comprises a processor. The processor is configured to divide an original image into a plurality of group images and rotate each of the group images by an angle to generate an output image.

Furthermore, the present invention further discloses an image processing method adapted for use in an image processing apparatus which comprises a processor. The processor executes the image processing method. The image processing method comprises the following steps of: (a) dividing an original image into a plurality of group images; and (b) rotating each of the group images by an angle to generate an output image.

The detailed technology and preferred embodiments implemented for the subject invention are described in the following paragraphs accompanying the appended drawings for people skilled in this field to well appreciate the features of the claimed invention.

### DESCRIPTION OF THE PREFERRED EMBODIMENT

The present invention mainly relates to an image processing apparatus and an image processing method. It shall be appreciated that, the following embodiments are only intended to exemplify the technical contents of the present invention but not to limit the scope of the present invention. In the following embodiments and attached drawings, elements unrelated to the present invention are omitted from depiction; and dimensional relationships among the individual elements in the attached drawings are illustrated only for the ease of understanding but not to limit the actual scale.

A first embodiment of the present invention is shown in FIG. 1, which is a schematic view of an image processing apparatus 1. The image processing apparatus 1 comprises a processor 11. The image processing apparatus 1 may be a camera, a video camera, a smart phone or any apparatus having the capability of processing images.

The processor 11 divides an original image 102 into a plurality of group images 104. Then, each of the group images 104 is rotated by an angle to generate an output image 106. In particular, the original image 102 is an image which contains a plurality of independent notes as shown in FIG. 2A. The processor 102 divides the original image 102 into a plurality of group images 104 through an analysis of the original image 102, as shown in FIG. 2B. Finally, the processor 11 rotates each of the group images 104 by an angle to make them upright and generates an output image 106 (as shown in FIG. 2C) to be read by a user.

An implementation of how the processor 11 divides the original image 102 into the plurality of group images 104 will be described hereinbelow. As distances between contents recorded in each of the notes are usually relatively short, the processor 11 firstly transforms the original image 102 into a grayscale image and then binarizes the grayscale image into a binary image. Subsequently, the processor 11 divides the binary image into a plurality of portions based on an 8-neighbor connectivity algorithm. The 8-neighbor connectivity algorithm is a technology conventionally known in the art and, thus, will not be further described herein.

Then, the processor 11 separates the portions into a plurality of groups according to a Euclidean distance between every two of the portions and generates the group images 104 according to the groups. In detail, the processor 11 computes a Euclidean distance between every two of the portions. If the Euclidean distances between some portions are less than a preset value, these portions are classified into a same group.

Furthermore, in another implementation, contents recorded in different notes are written with pens of different colors and the processor 11 further divides the original image 102 into a plurality of portions according to this. Firstly, the processor 11 analyzes a plurality of line colors of the original image 102 and divides the original image 102 into a plurality of portions according to the line colors. Subsequently, the portions are separated into a plurality of groups according to a Euclidean distance between every two of the portions, and the group images 104 are generated according to the groups.

Furthermore, in another implementation, contents recorded in different notes are written with pens of different line thicknesses and the processor 11 further divides the original image 102 into a plurality of portions according to this. Firstly, the processor 11 analyzes a plurality of line thicknesses of the original image 102 and divides the original image 102 into a plurality of portions according to the line thicknesses. Subsequently, the portions are separated into a plurality of groups according to a Euclidean distance between every two of the portions, and the group images 104 are generated according to the groups.

An implementation of how the processor 11 rotates each of the group images 104 by an angle will be described hereinbelow. Firstly, the processor 11 performs an optical character recognition on each of the group images 104 to recognize a plurality of characters and determines the angle by which each of the group images 104 is rotated according to a character direction of the characters of each of the group images. In detail, texts are usually written in the horizontal direction. Therefore, once characters are recognized, the horizontal direction of the note can be obtained to obtain the rotation angle.

Furthermore, in another implementation, the processor 11 may detect a grid in each of the group images 104 and determine the angle by which each of the group images 104 is rotated according to the grid of each of the group images 104. In detail, if the notes are written on paper having grids, the rotation angles can be obtained according to the square shape of the grids.

Furthermore, in another implementation, the processor 11 may perform an optical character recognition on each of the group images 104 to recognize a plurality of characters and determine the angle by which each of the group images 104 is rotated according to a periphery line of the characters of each of the group images 104. In detail, key points of texts are usually marked with horizontal lines in writing. Therefore, once characters are recognized, the rotation angle can be obtained according to the horizontal line around the characters.

A second embodiment of the present invention is shown in FIG. 2, which is a schematic view of an image processing apparatus 2. In this embodiment, the image processing apparatus 2 comprises not only the processor 11 but also a receiver 13 electrically connected to the processor 11.

An implementation of how the processor 11 divides the original image 102 into the plurality of group images 104 in this embodiment will be described. If there is one or more cameras (not shown) in a meeting room that capture images of the content environment of the meeting room to obtain one or more environmental images, the receiver 13 can receive at least one environmental image from at least one camera. The processor 11 can detect a plurality of faces of people in the at least one environmental image and determine the angle by which each of the group images 104 is rotated according to the faces.

Instead of detecting faces, the processor 11 may also detect a plurality of hands in the at least one environmental image instead and determine the angle by which each of the group images 104 is rotated according to the hands. Furthermore, the processor 11 may also detect a plurality of pens in the at least one environmental image instead and determine the angle by which each of the group images 104 is rotated according to the pens.

Furthermore, in another implementation, if there is one or more directional microphones (not shown) in the meeting room that record the content environment of the meeting to obtain one or more acoustic beam directions, the receiver 13 can further receive direction information of a plurality of acoustic beams from at least one directional microphone. The processor 11 can further determine the angle by which each of the group images 104 is rotated according to the direction information of the acoustic beams.

Furthermore, in another implementation, if an upper surface of a table on which the members in the meeting room write is a touch panel adapted to sense touches from the members' hands during writing, the receiver 13 can further receive a plurality of sensing signals from the touch panel. Each of the sensing signals is generated in response to a writing gesture of a user. In this case, the processor 11 can further determine the angle by which each of the group images 104 is rotated according to the sensing signals.

In addition, this embodiment differs from the first embodiment in that, the receiver 13 can receive the original image 102 from an image capturing apparatus (not shown) for processing by the processor 14. The image capturing apparatus may be a camera, a video camera or any handled apparatus equipped with an image capturing module.

A third embodiment of the present invention is shown in FIG. 3, which is a schematic view of an image processing apparatus 3. In this embodiment, the image processing apparatus 3 comprises not only the processor 11 and the receiver 13 but also an image capturing module 15 electrically connected to the processor 11. In this embodiment, the original image 102 is captured by the image capturing module 15 for processing by the processor 14 instead of being received by the receiver 13 from an image capturing apparatus. In this embodiment, the image processing apparatus 1 may be a camera, a video camera, a smart phone having an image capturing module or any apparatus capable of processing images and having an image capturing module.

A fourth embodiment of the present invention is shown in FIG. 5, which is a flowchart diagram of an image processing method of the present invention. The image processing method is adapted for use in an image processing apparatus which comprises a processor (e.g., the image processing apparatus 1 of the first embodiment, the image processing apparatus 3 of the second embodiment and the image processing apparatus 4 of the third embodiment). The image processing method is executed by the processor.

Firstly, in step S501, an original image is divided into a plurality of group images. Then, in step S503, each of the group images is rotated by an angle to generate an output image. In addition to the aforesaid steps, the fourth embodiment can also execute all the operations and functions set forth in the first, the second and the third embodiments. How the image processing method of the present invention executes these operations and functions will be readily appreciated by those of ordinary skill in the art based on the explanation of the first, the second and the third embodiments and, thus, will not be further described herein.

According to the above descriptions, the image processing apparatus of the present invention can analyze an image containing a plurality of notes, divide the image into a plurality of portions corresponding to the respective notes and rotate each of the portions to generate an upright output image. In this way, the present invention provides a relatively convenient image capturing and image processing mechanism by which users can obtain images of the respective notes more directly and quickly.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

### BRIEF DESCRIPTION OF THE DRAWINGS

FIG. 1 is a schematic view of an image processing apparatus 1 according to a first embodiment of the present invention;

FIGS. 2A-2c depict an original image 102, group images 104 and an output image 106 according to the first embodiment respectively;

FIG. 3 is a schematic view of an image processing apparatus 3 according to a second embodiment of the present invention;

FIG. 4 is a schematic view of an image processing apparatus 4 according to a third embodiment of the present invention; and

FIG. 5 is a flowchart diagram of an image processing method according to a fourth embodiment of the present invention.

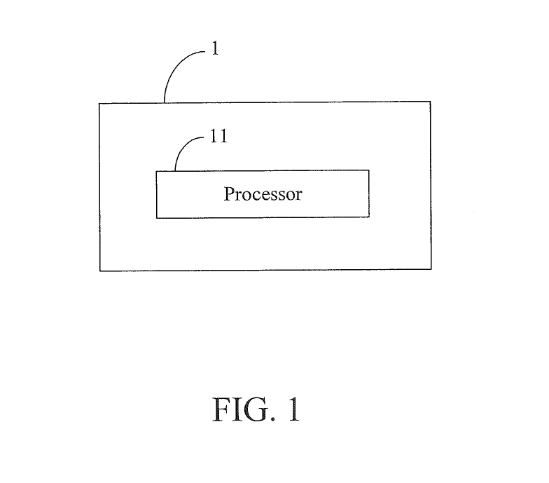

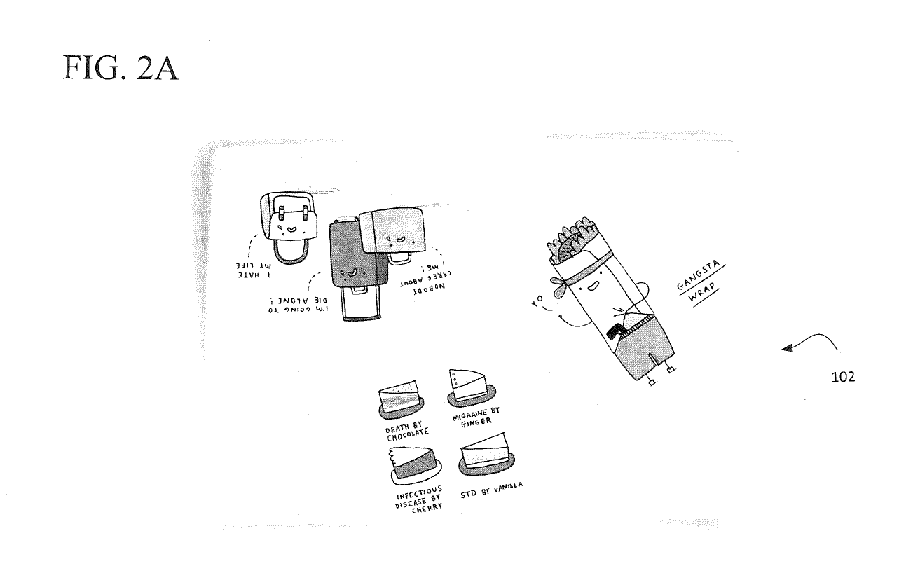

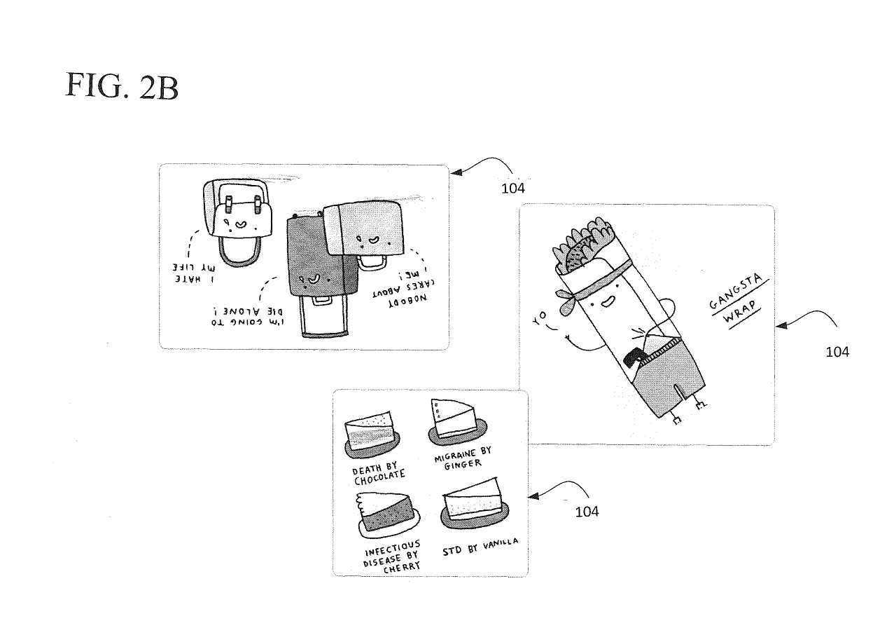

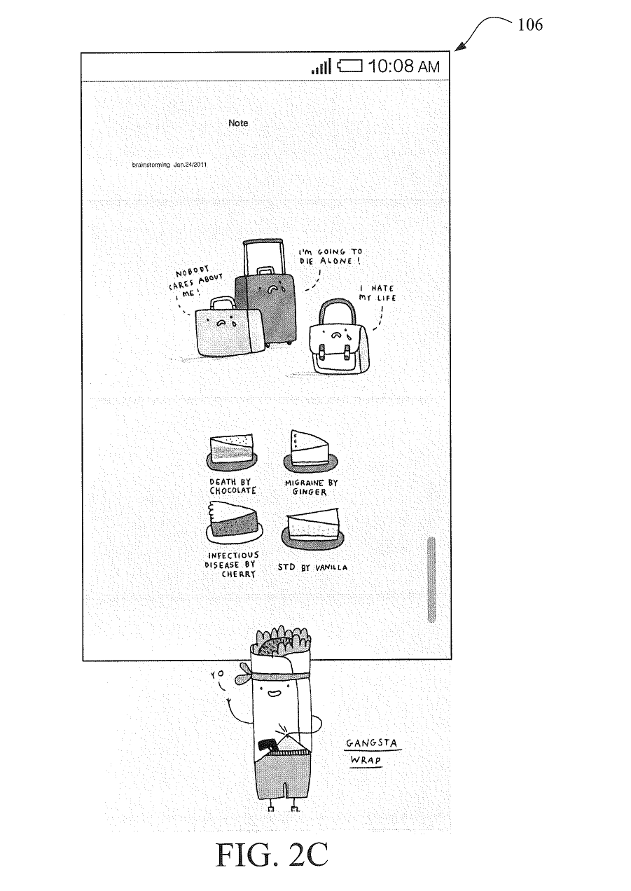

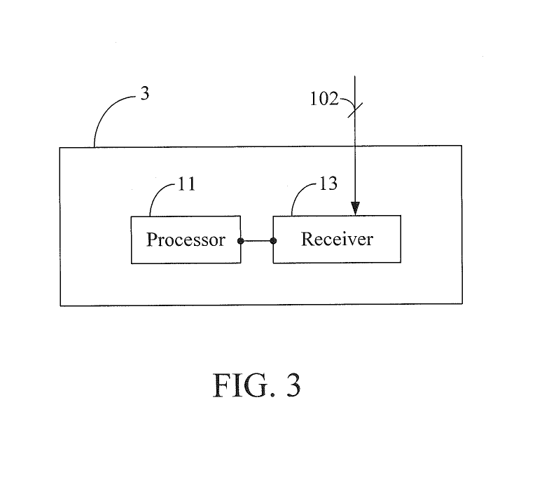

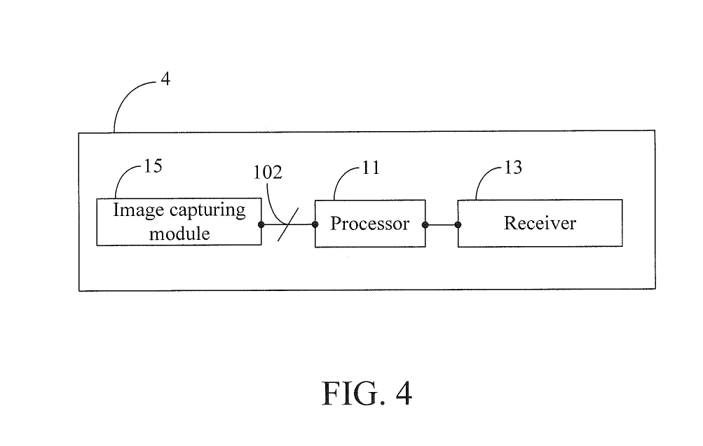

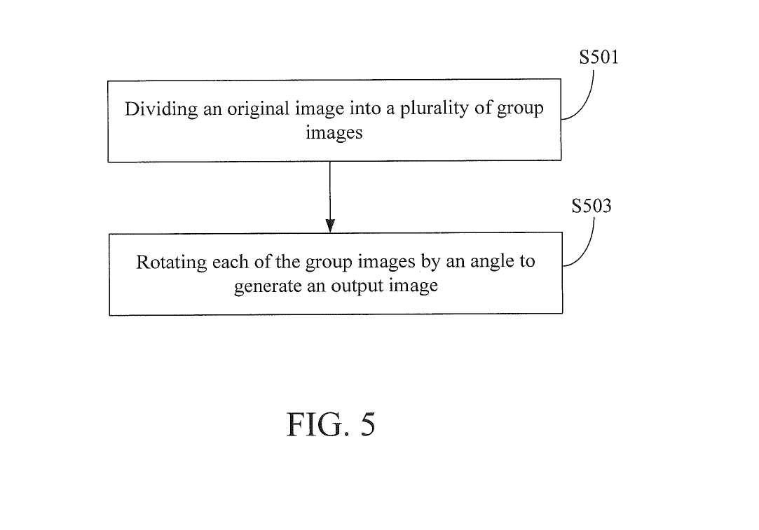

### BRIEF DESCRIPTION OF REFERENCE NUMERALS

1: image processing apparatus
3: image processing apparatus
4: image processing apparatus
11: processor
13: receiver
15: image capturing module
102: original image
104: group image
106: output image

1. An image processing apparatus, comprising:
a processor, being configured to divide an original image into a plurality of group images and rotate each of the group images by an angle to generate an output image.

2. The image processing apparatus as claimed in claim 1, further comprising a receiver electrically connected to the processor, being configured to receive the original image from an image capturing apparatus.

3. The image processing apparatus as claimed in claim 1, further comprising an image capturing module electrically connected to the processor and configured to capture the original image.

4. The image processing apparatus as claimed in claim 1, wherein the processor is further configured to:
transform the original image into a grayscale image;
binarize the grayscale image into a binary image;
divide the binary image into a plurality of portions based on an 8-neighbor connectivity algorithm;
separate the portions into a plurality of groups according to an Euclidean distance between every two of the portions; and
generate the group images according to the groups.

5. The image processing apparatus as claimed in claim 1, wherein the processor is further configured to:
analyze a plurality of line colors of the original image;
divide the original image into a plurality of portions according to the line colors;
separate the portions into a plurality of groups according to an Euclidean distance between every two of the portions; and
generate the group images according to the groups.

6. The image processing apparatus as claimed in claim 1, wherein the processor is further configured to:
analyze a plurality of line thicknesses of the original image;
divide the original image into a plurality of portions according to the line thicknesses;
separate the portions into a plurality of groups according to an Euclidean distance between every two of the portions; and
generating the group images according to the groups.

7. The image processing apparatus as claimed in claim 1, further comprising a receiver electrically connected to the processor, wherein the receiver is further configured to receive at least one environmental image from at least one camera, and the processor is further configured to detect a plurality of faces in the at least one environmental image and determine the angle by which each of the group images is rotated according to the faces.

8. The image processing apparatus as claimed in claim 1, further comprising a receiver electrically connected to the processor, wherein the receiver is further configured to receive at least one environmental image from at least one camera, and the processor is further configured to detect a plurality of hands in the at least one environmental image and determine the angle by which each of the group images is rotated according to the hands.

9. The image processing apparatus as claimed in claim 1, wherein the processor is further configured to perform an optical character recognition on each of the group images to recognize a plurality of characters, and determine the angle by which each of the group images is rotated according to a character direction of the characters of each of the group images.

10. The image processing apparatus as claimed in claim 1, further comprising a receiver electrically connected to the processor, wherein the receiver is further configured to receive at least one environmental image from at least one camera, and the processor is further configured to detect a plurality of pens in the at least one environmental image and determine the angle by which each of the group images is rotated according to the pens.

11. The image processing apparatus as claimed in claim 1, wherein the processor is further configured to detect a grid in each of the group images and determine the angle by which each of the group images is rotated according to the grid of each of the group images.

12. The image processing apparatus as claimed in claim 1, further comprising a receiver electrically connected to the processor, wherein the receiver is further configured to receive direction information of a plurality of acoustic beams from at least one directional microphone, and the processor is further configured to determine the angle by which each of the group images is rotated according to the direction information of the acoustic beams.

13. The image processing apparatus as claimed in claim 1, wherein the processor is further configured to perform an optical character recognition on each of the group images to recognize a plurality of characters and determine the angle by which each of the group images is rotated according to a periphery line of the characters of each of the group images.

14. The image processing apparatus as claimed in claim 1, further comprising a receiver electrically connected to the processor, wherein the receiver is further configured to receive a plurality of sensing signals from a touch panel disposed on an upper surface of a table, each of the sensing signals is generated in response to a writing gesture of a user, and the processor is further configured to determine the angle by which each of the group images is generated according to the sensing signals.

15. An image processing method for use in an image processing apparatus, the image processing apparatus comprising a processor, and the image processing method being executed by the processor and comprising the following steps of:
(a) dividing an original image into a plurality of group images; and
(b) rotating each of the group images by an angle to generate an output image.

16. The image processing method as claimed in claim 15, wherein the image processing apparatus further comprises a receiver electrically connected to the processor, and the method further comprises the following step before the step (a):
enabling the receiver to receive the original image from an image capturing apparatus.

17. The image processing method as claimed in claim 15, wherein the image processing apparatus further comprises an image capturing module electrically connected to the processor, and the method further comprises the following step before the step (a):
enabling the image capturing module to capture the original image.

18. The image processing method as claimed in claim 15, wherein the step (a) further comprises the following steps of:
(a1) transforming the original image into a grayscale image;
(a2) binarizing the grayscale image into a binary image;
(a3) dividing the binary image into a plurality of portions based on an 8-neighbor connectivity algorithm;
(a4) separating the portions into a plurality of groups according to an Euclidean distance between every two of the portions; and
(a5) generating the group images according to the groups.

19. The image processing method as claimed in claim 15, wherein the step (a) further comprises the following steps of:
(a1) analyzing a plurality of line colors of the original image;
(a2) dividing the original image into a plurality of portions according to the line colors;
(a3) separating the portions into a plurality of groups according to an Euclidean distance between every two of the portions; and
(a4) generating the group images according to the groups.

20. The image processing method as claimed in claim 15, wherein the step (a) further comprises the following steps of:
(a1) analyzing a plurality of line thicknesses of the original image;
(a2) dividing the original image into a plurality of portions according to the line thicknesses;
(a3) separating the portions into a plurality of groups according to an Euclidean distance between every two of the portions; and
(a4) generating the group images according to the groups.

21. The image processing method as claimed in claim 15, wherein the image processing apparatus further comprises a receiver, and the step (b) further comprises the following steps of:
(b1) enabling the receiver to receive at least one environmental image from at least one camera;
(b2) detecting a plurality of faces in the at least one environmental image; and
(b3) determining the angle by which each of the group images is rotated according to the faces.

22. The image processing method as claimed in claim 15, wherein the image processing apparatus further comprises a receiver, and the step (b) further comprises the following steps of:
(b1) enabling the receiver to receive at least one environmental image from at least one camera;
(b2) detecting a plurality of hands in the at least one environmental image; and
(b3) determining the angle by which each of the group images is rotated according to the hands.

23. The image processing method as claimed in claim 15, wherein the step (b) further comprises the following steps of:
(b1) performing an optical character recognition on each of the group images to recognize a plurality of characters; and
(b2) determining the angle by which each of the group images is rotated according to a character direction of the characters of each of the group images.

24. The image processing method as claimed in claim 15, wherein the image processing apparatus further comprises a receiver, and the step (b) further comprises the following steps of:
(b1) enabling the receiver to receive at least one environmental image from at least one camera;
(b2) detecting a plurality of pens in the at least one environmental image; and
(b3) determining the angle by which each of the group images is rotated according to the pens.

25. The image processing method as claimed in claim 15, wherein the step (b) further comprises the following steps of:
(b1) detecting a grid in each of the group images; and
(b3) determining the angle by which each of the group images is rotated according to the grid of each of the group images.

26. The image processing method as claimed in claim 15, wherein the image processing apparatus further comprises a receiver, and the step (b) further comprises the following steps of:
(b1) enabling the receiver to receive direction information of at least one acoustic beam from at least one directional microphone; and
(b2) determining the angle by which at least one of the group images is rotated according to the direction information of the at least one acoustic beam.

27. The image processing method as claimed in claim 15, wherein the step (b) further comprises the following steps of:
(b1) performing an optical character recognition on each of the group images to recognize a plurality of characters; and
(b2) determining the angle by which each of the group images according to a periphery line of the characters of each of the group images.

28. The image processing method as claimed in claim 15, wherein the image processing apparatus further comprises a receiver, and the step (b) further comprises the following steps of:
(b1) enabling the receiver to receive a plurality of sensing signals from a touch panel disposed on an upper surface of a table, each of the sensing signals being generated in response to a writing gesture of a user; and
(b2) determining the angle by which each of the group images is rotated according to the sensing signals.
